(19) United States
(12) Patent Application Publication
(10) Pub. No.: US 2006/0109228 A1
(43) Pub. Date: May 25, 2006

(54) Liquid crystal display (LCD) driving circuits and methods of driving same

(76) Inventor: Chang-Sig Kang, Suwon-si (KR)

Correspondence Address: MYERS BIGEL SIBLEY & SAJOVEC, PO BOX 37428, RALEIGH, NC, 27627, US

(21) Appl. No.: 11/204,977

(22) Filed: Aug. 16, 2005

(30) Foreign Application Priority Data
Nov. 22, 2004 (KR) 2004-95891

(51) Int. Cl. G09G 3/36

(52) U.S. Cl. 345/98

(57) ABSTRACT

An integrated circuit device includes a liquid crystal display (LCD) driver circuit. This LCD driver circuit includes a decoder and a multi-stage sample-hold circuit coupled to an output of the decoder. The LCD driver circuit supports different contrasts for the red, blue and green color signals. In particular, the LCD driver circuit is configured to convert red, blue and green data input signals having equivalent digital values into red, blue and green data output signals having unequal analog values (corresponding to different contrast levels).

### REFERENCE TO PRIORITY APPLICATION

This application claims priority to Korean Patent Application No. 2004-95891, filed Nov. 22, 2004, the disclosure of which is hereby incorporated herein by reference.

1. Field of the Invention

The present invention relates to display devices and, more particularly, to liquid crystal display (LCD) devices and methods of operating same.

2. Description of the Related Art

FIG. 1 is a block diagram of a conventional source driving IC 10. Referring to FIG. 1, the source driving IC 10 includes an analog voltage generator 11, registers REG1 through REG3Q, latch circuits L1 through L3Q, decoders D1 through D3Q, and amplifiers M1 through M3Q. The analog voltage generator 11 generates analog voltages AV1 through AVN (N is an integer) on the basis of external gamma voltages EV1 through EVK (K is an integer). The registers REG1 through REG3Q store R, G and B color signals r1 through r3Q, g1 through g3Q and b1 through b3Q of a digital data signal S_DAT, which are continuously received, in response to an input control signal DIO and outputs the stored R, G and B color signals r1 through r3Q, g1 through g3Q and b1 through b3Q, respectively. The latch circuits L1 through L3Q simultaneously latch and output the R, G and B color signals r1 through r3Q, g1 through g3Q and b1 through b3Q in response to a control signal CTL. The decoders D1 through D3Q each select one of the analog voltages AV1 through AVN in response to the latched R, G and B color signals r1 through r3Q, g1 through g3Q and b1 through b3Q and output the selected analog voltages.

To convert the R, G and B color signals r1 through r3Q, g1 through g3Q and b1 through b3Q into analog data signals respectively, the source driving IC 10 includes the decoders D1 through D3Q. Thus, the chip size and current consumption of the source driving IC 10 can be high. Furthermore, the analog voltage generator 11 generates the analog voltages AV1 through AVN based on the external gamma voltages EV1 through EVK having a single transmissivity-to-voltage curve as shown in FIG. 2. Accordingly, the source driving IC 10 cannot represent the R, G and B color signals with different contrasts.

### SUMMARY OF THE INVENTION

The present invention provides a source driving IC for an LCD, which converts digital data signals into analog data signals using only a small number of decoders to reduce the chip size and current consumption and display images corresponding to R, G and B color signals with different contrasts using a plurality of external gamma voltages having different transmissivity-to-voltage curves. The present invention also provides a driving method of the source driving IC for an LCD.

According to an aspect of the present invention, there is provided a source driving integrated circuit arranged along one side of an LCD panel to drive the LCD panel, which includes a decoder, a sample-hold unit, and an amplification unit. The decoder continuously outputs analog data signals in response to continuously received digital data signals. The sample-hold unit continuously latches the analog data signals and simultaneously outputs the latched analog data signal in response to an output strobe signal. The amplification unit increases the currents of the latched analog data signals and outputs the analog data signals as analog video signals. Preferably, the source driving integrated circuit further includes a data storage unit that receives and stores digital data signals corresponding to one horizontal line of the LCD panel in response to an input control signal, selects the stored digital data signals one at a time in response to control signals and continuously outputs the selected digital data signals to the decoder. Preferably, the source driving integrated circuit further includes an additional sample-hold unit and an analog voltage generator. The additional sample-hold unit latches gamma voltages and outputs the latched gamma voltages. The analog voltage generator generates a plurality of analog voltages based on the latched gamma voltages.

According to another aspect of the present invention, there is provided a driving method of a source driving integrated circuit for driving an LCD panel, which includes (a) generating analog voltages based on gamma voltages; (b) receiving and storing digital data signals corresponding to one horizontal line of the LCD panel in response to an input control signal, selecting the stored digital data signals one at a time in response to control signals and continuously outputting the selected digital data signals; (c) continuously outputting analog data signals in response to the digital data signals continuously received and the analog voltages; (d) continuously latching the analog data signals and simultaneously outputting the latched analog data signals in response to an output strobe signal; and (e) increasing the currents of the latched analog data signals and outputting the analog data signals as analog video signals.

### BRIEF DESCRIPTION OF THE DRAWINGS

The above and other features and advantages of the present invention will become more apparent by describing in detail exemplary embodiments thereof with reference to the attached drawings in which:

FIG. 1 is a block diagram of a conventional source driving IC;

FIG. 2 shows a transmissivity-to-voltage curve of external gamma voltages input to the source driving IC of FIG. 1;

FIG. 3 is a block diagram of a source driving IC according to the present invention;

FIG. 4 shows transmissivity-to-voltage curves of gamma voltages input to the second sample-hold unit shown in FIG. 3;

FIG. 5 is a circuit diagram of the second sample-hold unit shown in FIG. 3;

FIG. 6 is a circuit diagram of the first and second sample-hold circuits shown in FIG. 3;

FIG. 7 is a timing diagram of signals required for the operation of the source driving IC shown in FIG. 3; and

FIG. 8 shows a sampling period of analog data signals corresponding to the first horizontal line of the LCD panel shown in FIG. 7 in more detail.

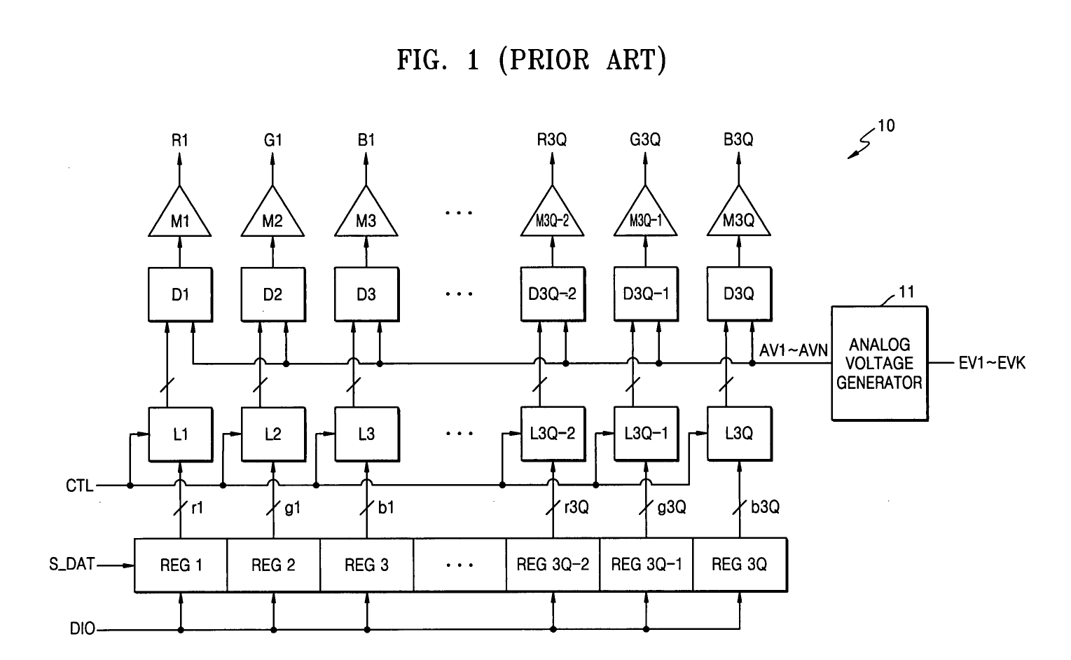

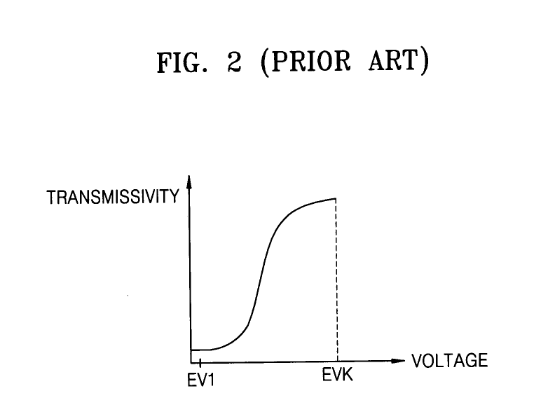

### DETAILED DESCRIPTION OF THE INVENTION

The present invention will now be described more fully with reference to the accompanying drawings, in which exemplary embodiments of the invention are shown. The invention may, however, be embodied in many different forms and should not be construed as being limited to the embodiments set forth herein; rather, these embodiments are provided so that this disclosure will be thorough and complete, and will fully convey the concept of the invention to those skilled in the art. Throughout the drawings, like reference numerals refer to like elements.

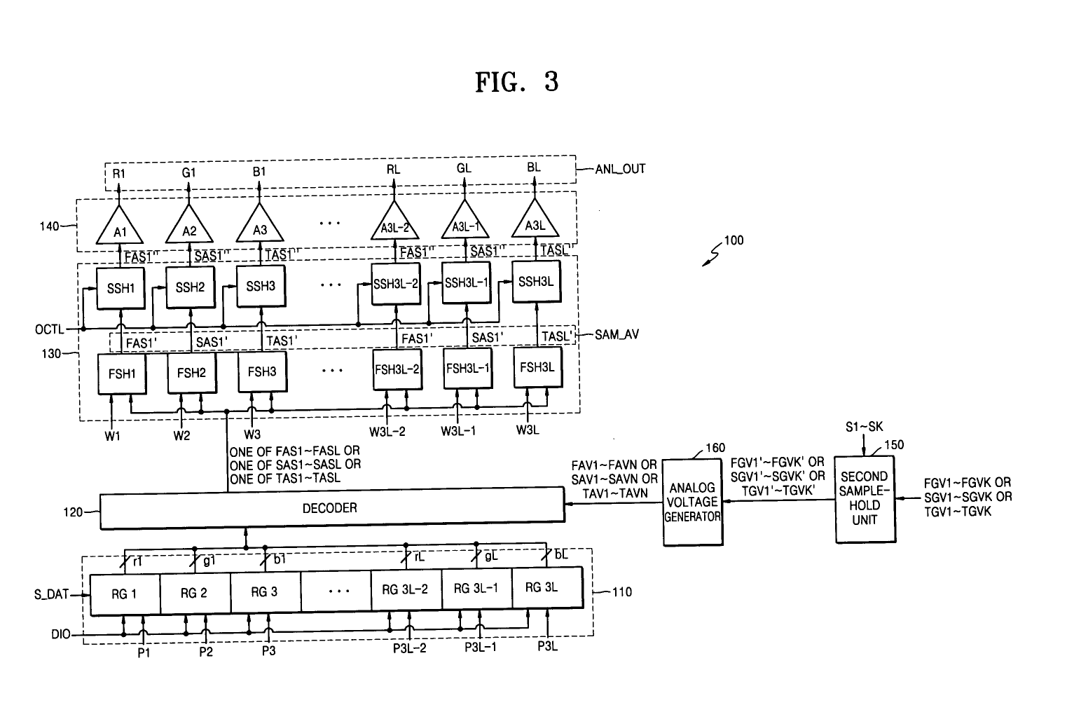

FIG. 3 is a block diagram of a source driving IC 100 according to the present invention. Referring to FIG. 3, the source driving IC 100 includes a data storage unit 110, a decoder 120, a first sample-hold unit 130, an amplification unit 140, a second sample-hold unit 150, and an analog voltage generator 160. The data storage unit 110 includes a plurality of data registers RG1 through RG3L (L is an integer). The data registers RG1 through RG3L store a digital data signal S_DAT corresponding to one horizontal line of an LCD panel (not shown) in response to an input control signal DIO. The digital data signal S_DAT includes R, G and B color signals r1 through rL, g1 through gL and b1 through bL. Specifically, the data register RG1 stores the R color signal r1, the data register RG2 stores the G color signal g1, and the data register RG3 stores the B color signal b1. The data registers RG4 through RG3L sequentially store the color signals r2, g2, b2, . . . , rL, gL and bL, respectively. Furthermore, the data registers RG1 through RG3L output the R, G and B color signals r1 through rL, g1 through gL and b1 through bL stored therein in response to control signals P1 through P3L, respectively. Here, one of the data registers RG1 through RG3L outputs one of the R color signals r1 through rL, one of the G color signals g1 through gL or one of the B color signals b1 through bL because each of the control signals P1 through P3L can be independently enabled. For example, when the control signal P1 is enabled and the control signals P2 through P3L are disabled, the data register RG1 outputs the R color signal r1. Here, each of the R, G and B color signals r1 through rL, g1 through gL and b1 through bL includes multiple bits.

The decoder 120 outputs an analog data signal (one of FAS1 through FASL, one of SAS1 through SASL, or one of TAS1 through TASL) in response to the values of the bits of one of the R, G and B color signals r1 through rL, g1 through gL and b1 through bL, received from one of the data registers RG1 through RG3L. More specifically, the decoder 120 selects one of first analog voltages FAV1 through FAVN (N is an integer) in response to the values of the bits of an R color signal (one of the signals r1 through rL) received from one of the data registers RG1, RG4, RG7, . . . , RG(3L-2) and outputs the selected analog voltage as the analog data signal (one of FAS1 through FASL). For example, when the R color signal r1 is an 8-bit signal, the decoder 120 selects one of 256 first analog voltage levels FAV1 through FAV256 in response to the values of the bits of the R color signal r1 and outputs it as the analog data signal FAS1.

The decoder 120 selects one of second analog voltages SAV1 through SAVN (N is an integer) in response to the values of the bits of a G color signal (one of the signals g1 through gL) received from one of the data registers RG2, RG5, RG8, . . . , RG(3L-1) and outputs the selected analog voltage as the analog data signal (one of SAS1 through SASL). For example, when the G color signal g1 is an 8-bit signal, the decoder 120 selects one of 256 second analog voltage levels SAV1 through SAV256 in response to the values of the bits of the G color signal g1 and outputs it as the analog data signal SAS1. Furthermore, The decoder 120 selects one of third analog voltages TAV1 through TAVN (N is an integer) in response to the values of the bits of a B color signal (one of the signals b1 through bL) received from one of the data registers RG3, RG6, RG9, . . . , RG3L and outputs the selected analog voltage as the analog data signal (one of TAS1 through TASL). For example, when the B color signal b1 is an 8-bit signal, the decoder 120 selects one of 256 third analog voltage levels TAV1 through TAV256 in response to the values of the bits of the B color signal b1 and outputs it as the analog data signal TAS1.

The first sample-hold unit 130 includes first sample-hold circuits FSH1 through FSH3L (L is an integer) and second sample-hold circuits SSH1 through SSH3L (L is an integer). The first sample-hold circuits FSH1 through FSH3L latch (or sample) the analog data signals FAS1 through FASL, SAS1 through SASL and TAS1 through TASL, received from the decoder 120, in response to switching control signals W1 through W3L (L is an integer), respectively. Here, when one of the first sample-hold circuits FSH1 through FSH3L is operated, other first sample-hold circuits stop their latching operations because the switching control signals W1 through W3L are enabled one at a time. For instance, when the switching control signal W1 is enabled and the switching control signals W2 through W3L are disabled, the first sample-hold circuit FSH1 latches the first analog data signal FAS1 and outputs the latched first analog data signal FSH1′. When the switching control signal W2 is enabled, the first sample-hold circuit FSH2 latches the second analog data signal SAS1 and outputs the latched second analog data signal SAS1′. When the switching control signal W3 is enabled, the first sample-hold circuit FSH3 latches the third analog data signal TAS1 and outputs the latched third analog data signal TAS1′. In this manner, the first sample-hold circuits FSH4 through FSH3L latch the analog data signals FAS2, SAS2, TAS2, . . . , FASL, SASL and TASL and output the latched analog data signals FAS2′, SAS2′, TAS2′, FASL′, SASL′ and TASL′, respectively.

The second sample-hold circuits SSH1 through SSH3L simultaneously latch (or sample) the latched analog data signals FAS1′, SAS1′, TAS1′, . . . , FASL′, SASL′ and TASL′, received from the first sample-hold circuits FSH1 through FSH3L, in response to an output strobe signal OCTL and respectively output the latched analog data signals FAS1″, SAS1″, TAS1″, . . . , FASL″, SASL″ and TASL″. When the first sample-hold circuits FSH1 through FSH3L latch analog data signals corresponding to the second horizontal line of the LCD panel, the second sample-hold circuits SSH1 through SSH3L output previously latched analog data signals corresponding to the first horizontal line of the LCD panel.

The amplification unit 140 includes amplifiers A1 through A3L. The amplifiers A1 through A3L increase the quantity of current of the latched analog data signals FAS1″, SAS1″, TAS1″, . . . , FASL″, SASL″ and TASL″ while maintaining the voltage levels of the latched analog data signals FAS1″, SAS1″, TAS1″, . . . , FASL″, SASL″ and TASL″ and output the analog data signals FAS1″, SAS1″, TAS1″, FASL″, SASL″ and TASL″ as analog video signals R1, R2, B1, . . . , BL, respectively.

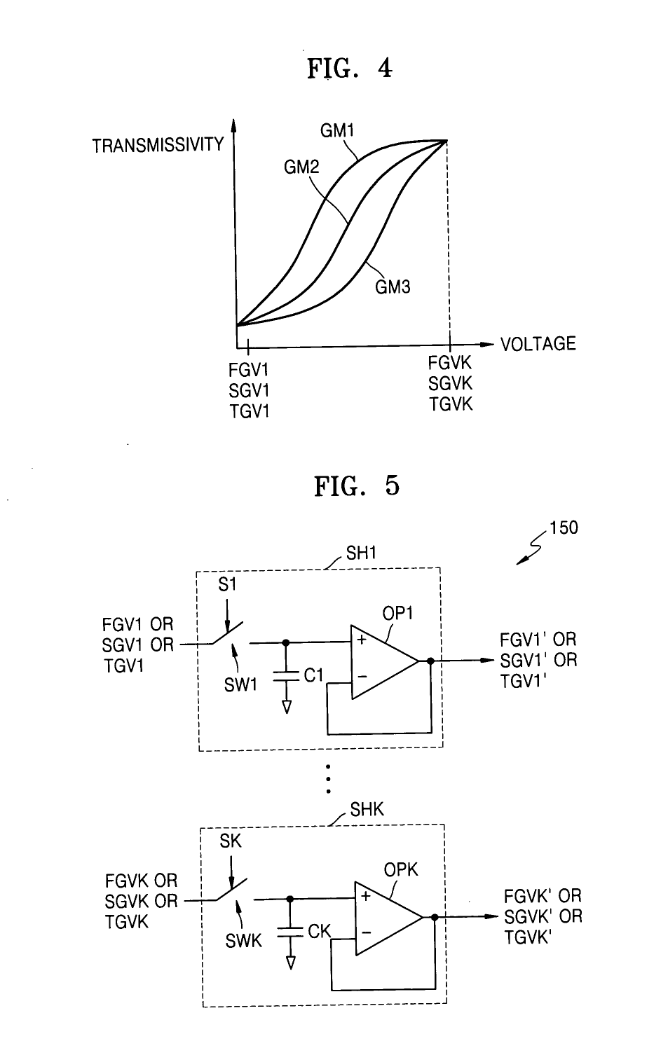

The second sample-hold unit 150 latches first gamma voltages FGV1 through FGVK (K is an integer), second gamma voltages SGV1 through SGVK (K is an integer) or third gamma voltages TGV1 through TGVK (K is an integer) in response to switching control signals S1 through SK (K is an integer). More specifically, when the first gamma voltages FGV1 through FGVK are received, the second sample-hold unit 150 latches the first gamma voltages FGV1 through FGVK and outputs the latched first gamma voltages FGV1′ through FGVK′. When the second gamma voltages SGV1 through SGVK are received, the second sample-hold unit 150 latches the second gamma voltages SGV1 through SGVK and outputs the latched second gamma voltages SGV1′ through SGVK′. When the third gamma voltages TGV1 through TGVK are received, the second sample-hold unit 150 latches the third gamma voltages TGV1 through TGVK and outputs the latched third gamma voltages TGV1′ through TGVK′. Here, the first, second and third gamma voltages FGV1 through FGVL, SGV1 through SGVK and TGV1 through TGVK are generated by an external gamma voltage generator (not shown) and form different transmissivity-to-voltage curves GM1, GM2 and GM3, respectively, as shown in FIG. 4. Since the first, second and third gamma voltages FGV1 through FGVK, SGV1 through SGVK and TGV1 through TGVK form the different transmissivity-to-voltage curves GM1, GM2 and GM3, respectively, the analog video signals R1 through RL, G1 through GL and B1 through BL, which correspond to the R, G and B color signals r1 through rL, g1 through gL and b1 through bL, respectively, can be displayed with different contrasts.

When the latched first gamma voltages FGV1′ through FGVK′ are received, the analog voltage generator 160 generates the first analog voltages FAV1 through FAVN based on the latched first gamma voltages FGV1′ through FGVK′. When the latched second gamma voltages SGV1′ through SGVK′ are received, the analog voltage generator 160 generates the second analog voltages SAV1 through SAVN based on the latched second gamma voltages SGV1′ through SGVK′. When the latched third gamma voltages TGV1′ through TGVK′ are received, the analog voltage generator 160 generates the third analog voltages TAV1 through TAVN based on the latched third gamma voltages TGV1′ through TGVK′. Here, N is larger than K. That is, the analog voltage generator 160 generates a larger number of analog voltages than the number of received gamma voltages. For example, the analog voltage generator 160 generates 256 first analog voltages FAV1 through FAV256 based on 18 latched first gamma voltages FGV1′ through FGV18′. The composition and operation of the analog voltage generator 160 can be understood by those skilled in the art, and thus, a detailed explanation therefor is omitted.

Alternatively, only gamma voltages GV1 through GVK (not shown) having a single transmissivity-to-voltage curve can be continuously input to the second sample-hold unit 150. In this case, the second sample-hold unit 150 latches the gamma voltages GV1 through GVK and outputs the latched gamma voltages GV1′ through GVK′. The analog voltage generator 160 generates analog voltages ALV1 through ALVN based on the latched gamma voltages GV1′ through GVK′. The decoder 120 selects one of the analog voltages ALV1 through ALVN in response to each of the R, G and B color signals r1 through rL, g1 through gL and b1 through bL. Consequently, all of the analog data signals FAS1 through FASL, SAS1 through SASL and TAS1 through TASL corresponding to the R, G and B color signals r1 through rL, g1 through gL and b1 through bL have the voltage level of one of the analog voltages ALV1 through ALVN. Accordingly, the analog video signals R1 through RL, G1 through GL and B1 through BL corresponding to the R, G and B color signals r1 through rL, g1 through gL and b1 through bL can be displayed with the same contrast.

FIG. 5 is a circuit diagram of the second sample-hold unit 150 shown in FIG. 3. Referring to FIG. 5, the second sample-hold unit 150 includes a plurality of sample-hold circuits SH1 through SHK (K is an integer). The sample-hold circuits SH1 through SHK include switches SW1 through SWK, capacitors C1 through CK and operational amplifiers OP1 through OPK, respectively. The switches SW1 through SWK are turned on or off in response to the switching control signals S1 through SK. Here, the switches SW1 through SWK are simultaneously turned on or off because the switching control signals S1 through SK are simultaneously enabled or disabled. When the switches SW1 through SWK are on, the capacitors C1 through CK are charged with the first gamma voltages FGV1 through FGVK, second gamma voltages SGV1 through SGVK or third gamma voltages TGV1 through TGVK, respectively. The operational amplifiers OP1 through OPK output the first, second or third gamma voltages FGV1′ through FGVK′, SGV1′ through SGVK′ or TGV1′ through TGVK′in response to the first gamma voltages FGV1 through FGVK, second gamma voltages SGV1 through SGVK or third gamma voltages TGV1 through TGVK with which the capacitors C1 through CK, respectively, are charged.

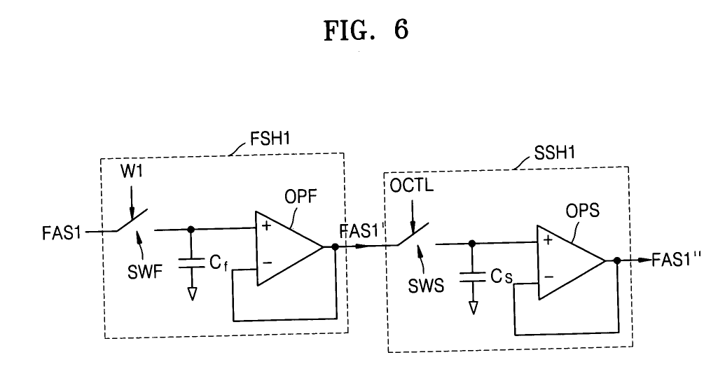

FIG. 6 is a circuit diagram of the first sample-hold circuit FSH1 and the second sample-hold circuit SSH1 shown in FIG. 3. The compositions and operations of the first sample-hold circuits FSH2 through FSH3L are similar to those of the first sample-hold circuit FSH1, and the compositions and operations of the second sample-hold circuits SSH2 through SSH3L are similar to those of the second sample-hold circuit SSH1. The first sample-hold circuit FSH1 includes a switch SWF, a capacitor C_{f} and an operational amplifier OPF. The second sample-hold circuit SSH1 includes a switch SWS, a capacitor Cₛ and an operational amplifier OPS. The switch SWF is turned on or off in response to the switching control signal W1. When the switch SWF is on, the capacitor C_{f} is charged to the voltage level of the analog data signal FAS1. Subsequently, when the switch SWS is on, the operational amplifier OPF outputs the analog data signal FAS1′ in response to the voltage of the analog data signal FAS1, with which the capacitor C_{f} is charged, and the capacitor Cₛ is charged to the voltage level of the analog data signal FAS1′. The operational amplifier OPS outputs the analog data signal FAS1′ in response to the voltage of the analog data signal FAS1′, charged in the capacitor Cₛ.

The operation of the source driving IC 100 will now be explained. First of all, the second sample-hold unit 150 latches the gamma voltages FGV1 through FGVK, SGV1 through SGVK or TGV1 through TGVK in response to the switching control signals S1 through SK and outputs the latched gamma voltages FGV1′ through FGVK′, SGV1′ through SGVK′ or TGV1′ through TGVK′. The analog voltage generator 160 generates the analog voltages FAV1 through FAVN, SAV1 through SAVN or TAV1 through TAVN based on the latched gamma voltages FGV1′ through FGVK′, SGV1′ through SGVK′ or TGV1′ through TGVK′. The data registers RG1 through RG3L of the data storage unit 110 store the R, G and B color signals r1 through rL, g1 through gL and b1 through bL of the digital data signal S_DAT for one horizontal line of the LCD panel in response to the input control signal DIO and continuously output the R, G and B color signals r1 through rL, g1 through gL and b1 through bL one at a time in response to the control signals P1 through P3L.

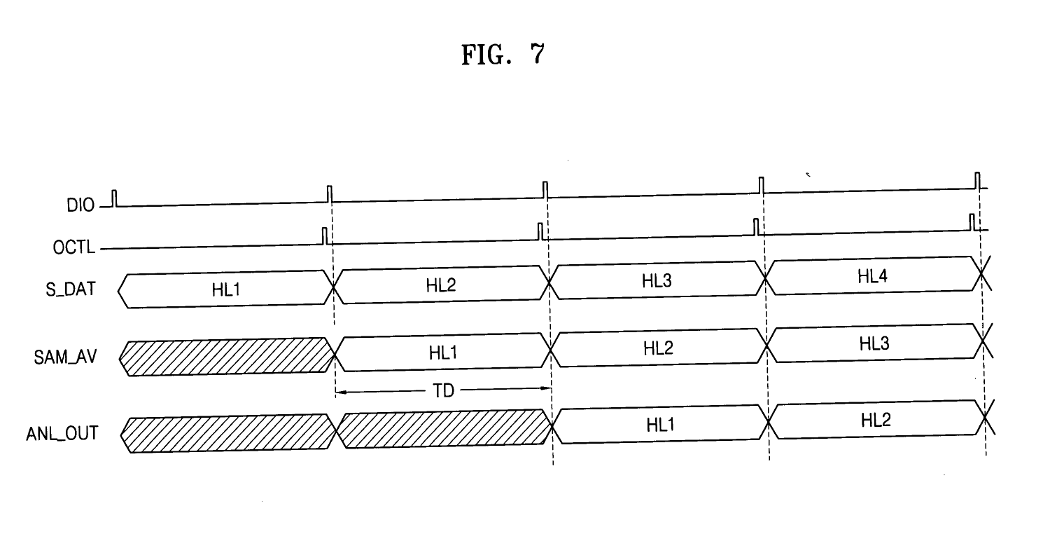

Referring to FIG. 7, when the input control signal DIO is firstly enabled, the data registers RG1 through RG3L store the R, G and B color signals r1 through rL, g1 through gL and b1 through bL of the digital data signal S_DAT corresponding to the first horizontal line HL1 of the LCD panel and continuously output the stored signals one at a time. In this manner, the data registers RG1 through RG3L store the R, G and B color signals r1 through rL, g1 through gL and b1 through bL of the digital data signal S_DAT corresponding to each horizontal line of the LCD panel in the order of HL2, HL3 and HL4 and output the stored signals one at a time whenever the input control signal DIO is enabled.

Then, the decoder 120 selects the analog voltage (one of FAV1 through FAVN, one of SAV1 through SAVN or one of TAV1 through TAVN) corresponding to bit values of the continuously received R, G and B color signals r1 through rL, g1 through gL and b1 through bL and outputs an analog data signal (one of FAS1 through FASL, one of SAS1 through SASL or one of TAS1 through TASL).

The first sample-hold circuits FSH1, FSH4, FSH7, . . . , FSH(3L-2) latch the analog data signals FAS1 through FASL in response to the switching control signals W1, W4, W7 , . . . , W(3L-2) and output the latched analog data signals FAS1′ through FASL′. The first sample-hold circuits FSH2, FSH5, FSH8, . . . , FSH(3L-1) latch the analog data signals SAS1 through SASL in response to the switching control signals W2, W5, W8, . . . , W(3L-1) and output the latched analog data signals SAS1′ through SASL′. The first sample-hold circuits FSH3, FSH6, FSH9, . . . , FSH3L latch the analog data signals TAS1 through TASL in response to the switching control signals W3, W6, W9, . . . , W3L and output the latched analog data signals TAS1′ through TASL′.

The second sample-hold circuits SSH1 through SSH3L simultaneously latch the latched analog data signals FAS1′ through FASL′, SAS1′ through SASL′ and TAS1′ through TASL′ in response to the output strobe signal OCTL and respectively output the latched analog data signals FAS1′ through FASL′, SAS1′ through SASL′ and TAS1′ through TASL′. As shown in FIG. 7, the second sample-hold circuits SSH1 through SSH3L latch the analog data signals FAS1′ through FASL′, SAS1′ through SASL′ and TAS1′ through TASL′ corresponding to each horizontal line in the order of HL1, HL2, HL3 and HL4 and output the latched analog data signals FAS1′ through FASL′, SAS1′ through SASL′ and TAS1′ through TASL′ whenever the output strobe signal OCTL is enabled.

Subsequently, the amplification unit 140 increases the currents of the latched analog data signals FAS1′ through FASL′, SAS1′ through SASL′ and TAS1′ through TASL′ corresponding to each horizontal line in the order of HL1, HL2, HL3 and HL4 and outputs the latched analog data signals as analog video signals R1 through RL, G1 through GL and B1 through BL of an output video signal ANL_OUT.

As described above, the process of storing the digital data signal S_DAT corresponding to one horizontal line of the LCD panel, the process of sampling the analog data signals FAS1 through FASL, SAS1 through SASL and TAS1 through TASL corresponding to the horizontal line, and the process of displaying the analog video signals R1 through RL, G1 through GL and B1 through BL corresponding to the horizontal line are each executed at independent points of time. Accordingly, a period of time required for the first sample-hold circuits FSH1 through FSH3L to latch (or sample) the analog data signals FAS1 through FASL, SAS1 through SASL and TAS1 through TASL can be sufficiently secured, and thus there is no need for the first sample-hold circuits FSH1 through FSH3L to operate at a high speed.

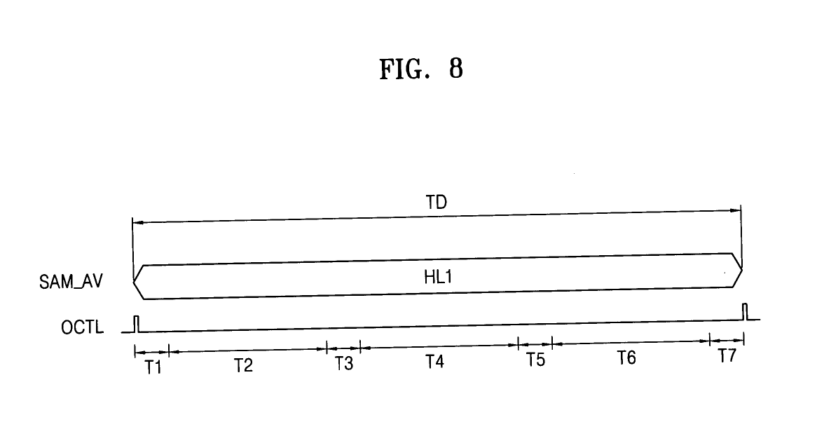

FIG. 8 shows a sampling period TD of the analog data signals corresponding to the first horizontal line of the LCD panel shown in FIG. 7 in detail. Referring to FIG. 8, the second sample-hold unit 150 latches the first gamma voltages FGV1 through FGVK and outputs the latched first gamma voltages FGV1′ through FGVK′ during a period T1. During a period T2, the first sample-hold circuits FSH1, FSH4, FSH7, . . . , FSH(3L-2) sequentially latch the analog data signals FAS1 through FASL corresponding to the R color signals r1 through rL. Here, the data registers RG1, RG4, RG7, . . . , RG(3L-2) sequentially output the R color signals r1 through rL, respectively, in response to the sequentially enabled control signals P1, P4 , P7, . . . , P(3L-2).

During a period T3, the second sample-hold unit 150 latches the second gamma voltages SGV1 through SGVK and outputs the latched second gamma voltages SGV1′ through SGVK′. During a period T4, the first sample-hold circuits FSH2, FSH5, FSH8, . . . , FSH(3L-1) sequentially latch the analog data signals SAS1 through SASL corresponding to the G color signals g1 through gL. Here, the data registers RG2, RG5, RG8, . . . , RG(3L-1) sequentially output the G color signals g1 through gL, respectively, in response to the sequentially enabled control signals P2, P5, P8, . . . , P(3L-1). During a period T5, the second sample-hold unit 150 latches the third gamma voltages TGV1 through TGVK and outputs the latched third gamma voltages TGV1′ through TGVK′. During a period T6, the first sample-hold circuits FSH3, FSH6, FSH9, . . . , FSH3L sequentially latch the analog data signals TAS1 through TASL corresponding to the B color signals b1 through bL. Here, the data registers RG3, RG6, RG9, . . . , RG3L sequentially output the B color signals b1 through bL, respectively, in response to the sequentially enabled control signals P3, P6, P9, . . . , P3L. In FIG. 8, a period T7 is a remaining interval.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A display driver circuit, comprising:
a decoder configured to generate a first plurality of analog display data signals in response to a plurality of digital display data signals and a first plurality of analog voltages;
a sample-hold circuit responsive to the first plurality of analog display data signals; and
an amplification circuit electrically coupled to an output of said sample-hold circuit.

2. The driver circuit of claim 1, wherein said decoder is configured so that the digital display data signals are used to select which of the first plurality of analog voltages are to be output as analog display data signals.

3. The driver circuit of claim 1, wherein said decoder is further responsive to a second plurality of analog voltages and a third plurality of analog voltages; and wherein the plurality of digital display data signals includes a plurality of red data signals, a plurality of blue data signals and a plurality of green data signals.

4. The driver circuit of claim 3, wherein said decoder is configured so that the red data signals are used to select which of the first plurality of analog voltages are to be output as first analog display data signals, the blue data signals are used to select which of the second plurality of analog voltages are to be output as second analog display data signals and the green data signals are used to select which of the third plurality of analog voltages are to be output as third analog display data signals.

5. The driver circuit of claim 4, wherein the first, second and third analog display data signals have values that support different red, blue and green display contrasts when selected by said decoder.

6. An integrated circuit device, comprising:
an LCD driver circuit configured to convert red, blue and green data input signals having equivalent digital values into red, blue and green data output signals having unequal analog values.

7. A source driving integrated circuit arranged along one side of an LCD panel to drive the LCD panel, comprising:
a decoder continuously outputting analog data signals in response to continuously received digital data signals;
a sample-hold unit continuously latching the analog data signals and simultaneously outputting the latched analog data signal in response to an output strobe signal; and
an amplification unit increasing the currents of the latched analog data signals and outputting the analog data signals as analog video signals.

8. The source driving integrated circuit of claim 7, further comprising a data storage unit receiving and storing digital data signals corresponding to one horizontal line of the LCD panel in response to an input control signal, selecting the stored digital data signals one at a time in response to control signals and continuously outputting the selected digital data signals to the decoder.

9. The source driving integrated circuit of claim 8, wherein the data storage unit includes a plurality of data registers that respectively store the digital data signals in response to the input control signal and output the stored digital data signals in response to the respective control signals and, when one of the plurality of data registers outputs the corresponding digital data signal, other data registers stop their operations of outputting the digital data signals.

10. The source driving integrated circuit of claim 8, further comprising:
an additional sample-hold unit latching gamma voltages and outputting the latched gamma voltages; and
an analog voltage generator generating a plurality of analog voltages based on the latched gamma voltages.

11. The source driving integrated circuit of claim 10, wherein the additional sample-hold unit includes a plurality of sample-hold circuits simultaneously latching the gamma voltages in response to switching control signals.

12. The source driving integrated circuit of claim 10, wherein the digital data signals each include a plurality of bits, and the decoder selects one of the plurality of analog voltages in response to the values of each of the bits and outputs the selected analog voltage as one of the analog data signals.

13. The source driving integrated circuit of claim 7, wherein the sample-hold unit comprises:
first sample-hold circuits firstly latching the analog data signals in response to switching control signals and outputting the firstly latched analog data signals; and
second sample-hold circuits simultaneously secondly latching the firstly latched analog data signals in response to the output strobe signal and simultaneously outputting the secondly latched analog data signals,
wherein, when one of the first sample-hold circuits executes its latching operation, other first sample-hold circuits stop their latching operations.

14. The source driving integrated circuit of claim 13, wherein the second sample-hold circuits output analog data signals corresponding to the first horizontal line of the LCD panel when the first sample-hold circuits latch analog data signals corresponding to the second horizontal line of the LCD panel.

15. The source driving integrated circuit of claim 10, wherein the digital data signals corresponding to one horizontal line of the LCD panel include R color signals, G color signals and B color signals, the gamma voltages include first gamma voltages corresponding to the R color signals, second gamma voltages corresponding to the G color signals and third gamma voltages corresponding to the B color signals, the plurality of analog voltages include first analog voltages, second analog voltages and third analog voltages, and the analog voltage generator generates the first analog voltages based on the first gamma voltages, generates the second analog voltages based on the second gamma voltages and generates the third analog voltages based on the third gamma voltages.

16. The source driving integrated circuit of claim 15, wherein the additional sample-hold unit sequentially latches and outputs the first, second and third gamma voltages, the data storage unit continuously outputs the R color signals when the analog voltage generator generates the first analog voltages, the data storage unit continuously outputs the G color signals when the analog voltage generator generates the second analog voltages, the data storage unit continuously outputs the B color signals when the analog voltage generator generates the third analog voltages, the decoder selects and outputs one of the first analog voltages in response to each of the R color signals, the decoder selects and outputs one of the second analog voltages in response to each of the G color signals, and the decoder selects and outputs one of the third analog voltages in response to each of the B color signals.

17. The source driving integrated circuit of claim 15, wherein the first gamma voltages, second gamma voltages and third gamma voltages respectively form different transmissivity-to-voltage curves.

18. A driving method of a source driving integrated circuit for driving an LCD panel comprising:
(a) generating analog voltages based on gamma voltages;
(b) receiving and storing digital data signals corresponding to one horizontal line of the LCD panel in response to an input control signal, selecting the stored digital data signals one at a time in response to control signals and continuously outputting the selected digital data signals;
(c) continuously outputting analog data signals in response to the digital data signals continuously received and the analog voltages;
(d) continuously latching the analog data signals and simultaneously outputting the latched analog data signals in response to an output strobe signal; and
(e) increasing the currents of the latched analog data signals and outputting the analog data signals as analog video signals.

19. The driving method of claim 18, wherein the digital data signals corresponding to one horizontal line of the LCD panel include R color signals, G color signals and B color signals, the gamma voltages include first gamma voltages corresponding to the R color signals, second gamma voltages corresponding to the G color signals and third gamma voltages corresponding to the B color signals, the first, second and third gamma voltages respectively form different transmissivity-to-voltage curves, the plurality of analog voltages include first analog voltages, second analog voltages and third analog voltages, and the generating of the analog voltages comprises:
(a1) latching the first gamma voltages and generating the first analog voltages based on the latched first gamma voltages;
(a2) latching the second gamma voltages and generating the second analog voltages based on the latched second gamma voltages; and
(a3) latching the third gamma voltages and generating the third analog voltages based on the latched third gamma voltages.

20. The driving method of claim 19, wherein the receiving and staring of the digital data signals comprises:
(b1) selecting the R color signals one at a time and continuously outputting the selected R color signals;
(b2) selecting the G color signals one at a time and continuously outputting the selected G color signals; and
(b3) selecting the B color signals one at a time and continuously outputting the selected B color signals, and the (c) comprises:
(c1) selecting one of the first analog voltages in response to each of the R color signals and outputting the selected first analog voltage as one of the analog data signals;
(c2) selecting one of the second analog voltages in response to each of the G color signals and outputting the selected second analog voltage as another one of the analog data signals;
(c3) selecting one of the third analog voltages in response to each of the B color signals and outputting the selected third analog voltage as another different one of the analog data signals.

21. The driving method of claim 18, wherein the continuously latching of the analog data signals comprises:
(d1) firstly latching the analog data signals in response to switching control signals and outputting the first latched analog data signals; and
(d2) simultaneously secondly latching the firstly latched analog data signals in response to the output strobe signal and simultaneously outputting the secondly latched analog data signals,
wherein, when the analog data signals are firstly latched, the analog data signals are sequentially latched.

22. The driving method of claim 21, wherein the (d) further comprises (d3) simultaneously outputting analog data signals corresponding to the first horizontal line of the LCD panel, which are secondly latched previously, when analog data signals corresponding to the second horizontal line of the LCD are firstly latched.
